(19) United States
(12) Patent Application Publication
(10) Pub. No.: US 2017/0257606 A1
(43) Pub. Date: Sep. 7, 2017

(54) AIRCRAFT MOUNTED DISPLAY MODULE

(71) Applicant: GOODRICH LIGHTING SYSTEMS, INC., Oldsmar, FL (US)

(72) Inventors: Nilesh R. Walke, Kalyan West (IN); Amar Patel, Bangalore (IN)

(21) Appl. No.: 15/156,754

(22) Filed: May 17, 2016

(30) Foreign Application Priority Data
Mar. 2, 2016 (IN) 201611007417

(51) Int. Cl. H04N 9/31; B64D 47/02; B64C 25/10

(52) U.S. Cl. CPC H04N 9/3141; B64C 25/10; B64D 47/02

(57) ABSTRACT

An aircraft includes an aircraft body including one or more exterior surfaces and a projector secured to a component of the aircraft. The projector is configured to selectably project one or more images on the one or more exterior surfaces. A method of displaying a projected image on an aircraft surface includes moving a landing gear assembly of the aircraft from a retracted position to an extending position, activating a projector disposed at the landing gear assembly, and displaying a projected image at the aircraft surface via activation of the projector.

### CROSS REFERENCE TO RELATED APPLICATIONS

This application claims the benefit of an earlier filing date from Indian Application Serial No. 201611007417 filed Mar. 2, 2016, the entire disclosure of which is incorporated herein by reference.

### BACKGROUND

The subject matter disclosed herein relates to aircraft. More specifically, the present disclosure relates to informational displays projected onto aircraft surfaces.

It has recently become more common to see advertisements and other informational messages on articles related to commercial aircraft travel. Advertisements and other messages can now be commonly found on boarding passes, security tags, luggage tags, inflight entertainment systems, and the like. Some aircraft operators have gone to the extent of painting portions of the aircraft structure, such as the wings, vertical tail or underside of the fuselage with commercial images or advertisements. This takes advantage of typically unused space to enhance aircraft operator revenues. Such painted images, however are fixed in nature and expensive, time consuming and hazardous to apply and replace. Further, such images typically cannot be viewed at night. The art would well receive solutions to take better advantage of such spaces for commercial advertisement images or messages.

### SUMMARY

In one embodiment, an aircraft includes an aircraft body including one or more exterior surfaces and a projector secured to a component of the aircraft. The projector is configured to selectably project one or more images on the one or more exterior surfaces.

Additionally or alternatively, in this or other embodiments a controller is operably connected to the projector to command projection of the one or more images on the one or more exterior surfaces.

Additionally or alternatively, in this or other embodiments the image is one of a static image or a dynamic image.

Additionally or alternatively, in this or other embodiments the component is a landing gear assembly of the aircraft.

Additionally or alternatively, in this or other embodiments the projector is activated when the landing gear assembly is in an extended position, thereby projecting the one or more images.

Additionally or alternatively, in this or other embodiments the projector is deactivated when the landing gear assembly is in a retracted position, thereby not projecting the one or more images.

Additionally or alternatively, in this or other embodiments the one or more exterior surfaces are viewable from ground level during normal flight operations of the aircraft.

Additionally or alternatively, in this or other embodiments the one or more exterior surfaces are one or more of wing surfaces or fuselage surfaces.

Additionally or alternatively, in this or other embodiments the projector is operably connected to an aircraft electrical system.

Additionally or alternatively, in this or other embodiments the projector is operably connected to a projector power source independent of an aircraft electrical system.

Additionally or alternatively, in this or other embodiments the one or more images include one or more commercial advertisements.

Additionally or alternatively, in this or other embodiments the one or more images are changeable during operation of the aircraft.

Additionally or alternatively, in this or other embodiments the projector is a laser projector.

In another embodiment, an image display system for an aircraft includes a projector secured to an aircraft component to selectably project an image on a surface of the aircraft.

Additionally or alternatively, in this or other embodiments the projector is a laser projector.

Additionally or alternatively, in this or other embodiments a programmable controller is operably connected to the projector.

Additionally or alternatively, in this or other embodiments the controller is configured to change the one or more images during operation of the aircraft.

Additionally or alternatively, in this or other embodiments a projector power source independent of an aircraft electrical system is operably connected to the projector.

In yet another embodiment, a method of displaying a projected image on an aircraft surface includes moving a landing gear assembly of the aircraft from a retracted position to an extending position, activating a projector disposed at the landing gear assembly, and displaying a projected image at the aircraft surface via activation of the projector.

Additionally or alternatively, in this or other embodiments the projected image is changed during operation of the aircraft.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic view of an underside of an embodiment of an aircraft;

FIG. 2 is another schematic view of an underside of an aircraft;

FIG. 3 is a perspective view of an embodiment of a landing gear assembly for an aircraft;

FIG. 4 is another perspective view a portion of a landing gear assembly for an aircraft; and

FIG. 5 is a partial view of an interior wall of an aircraft.

### DETAILED DESCRIPTION

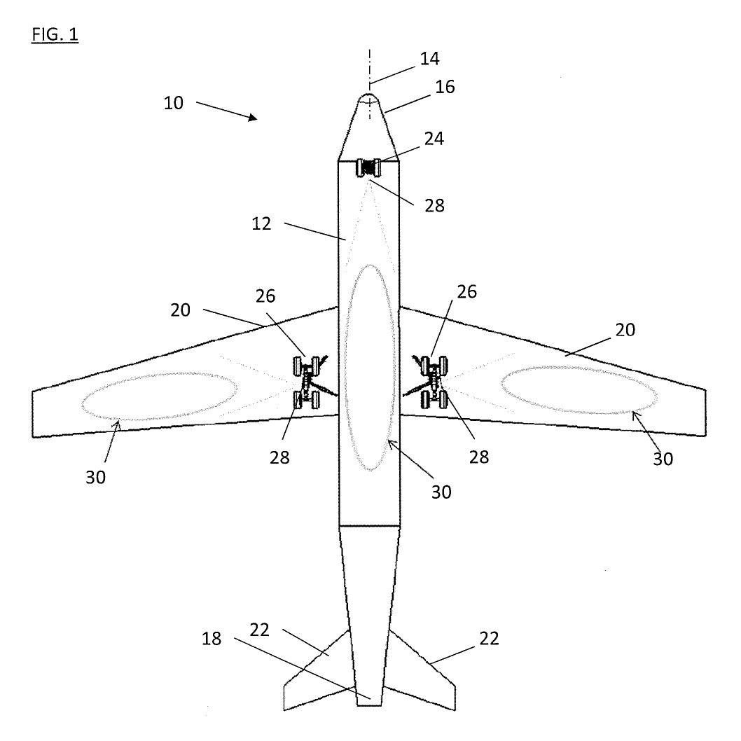

Shown in FIG. 1 is a schematic view of an aircraft 10. The aircraft 10 includes a fuselage 12 extending along a central axis 14 of the aircraft 10 from a nose 16 to a tail 18 of the aircraft 10. Wings 20 extend laterally from the fuselage 12 to provide lift for the aircraft 10. In some embodiments, the aircraft 10 may further include horizontal stabilizers 22 extending from the fuselage 12 rearward of the wings 20. The aircraft 10 may further include landing gear assemblies extendible for ground operations of the aircraft 10, for example, landing and takeoff of the aircraft 10. In some embodiments, the landing gear assemblies may include a nose landing gear assembly 24 and one or more main landing gear assemblies 26, which may be positioned at the wings 20 as shown in FIG. 1 or alternatively at the fuselage 12. While the embodiment of FIG. 1 includes a nose landing gear assembly 24 and two main landing gear assemblies 26, it is to be appreciated that in some embodiments, there may be other or additional landing gear assemblies, such as a tail landing gear assembly (not shown).

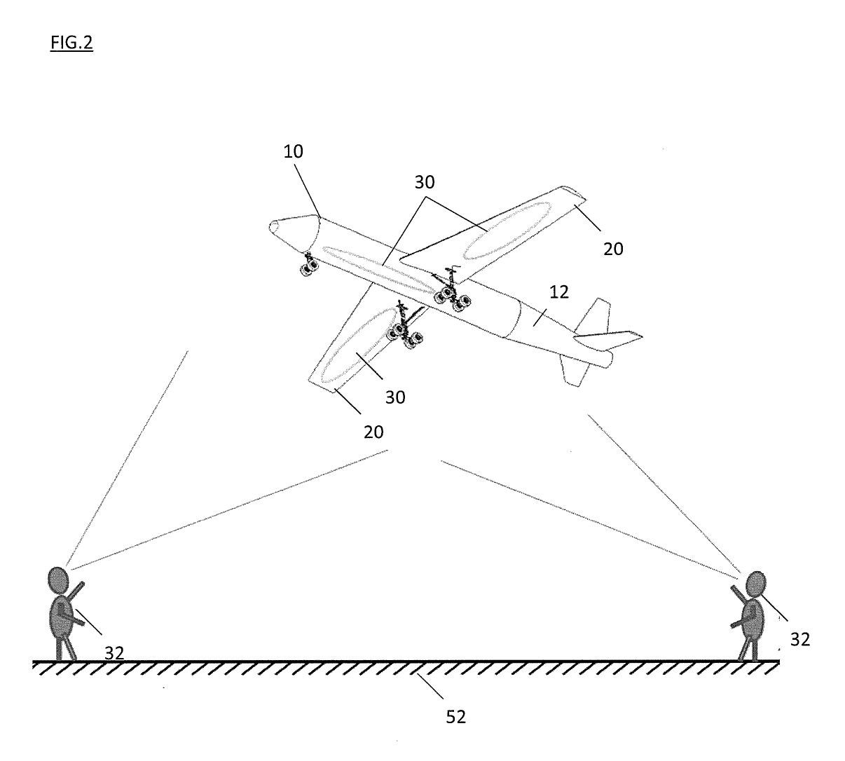

The aircraft 10 includes one or more projectors 28 configured to project one or more images 30 on surfaces of the aircraft 10, such as wing 20 surfaces or fuselage surfaces 12. As shown in FIG. 1 and in FIG. 2, the projectors 28 are located as to project images 30 on surfaces of an underside of the aircraft 10 so as to be viewable by an audience, represented at 32, located at ground level 52 during normal aircraft operations. While such a configuration is shown in FIGS. 1 and 2, it is to be appreciated that in other embodiments the projectors may be configured to project images anywhere on an outer, viewable surface of the aircraft 10.

The images 30 displayed on the aircraft 10 surfaces may be static images, or alternatively may be dynamic images or video projections. The images 30 may depict, for example, commercial advertisement, flight operator identification, informational messages, or the like. In some embodiments, the projector 28 is a laser based system, which projects laser light into the selected aircraft 10 surfaces. In other embodiments, the projector 28 may utilize other technology such as a projection lamp, light emitting diode (LED) bulbs, or any such illumination technology. As best shown in FIG. 3, the projector 28 may be connected to a controller 34 and a power source 36 via an electrical harness 38 and a junction box 40 to control operation of the projector 28. The power source 36 may be an aircraft electrical system, or alternatively may be a battery operably connected to the projector 28 independent of the aircraft electrical system. Further, the projector 28 may be operably connected to the controller 34 via a wireless connection, for example, a WiFi connection to control the projection of images 30 by the projector 28.

The controller 34 is a programmable device configured to direct projection of selected images 30 by the projector 28. The image 30 display may be therefore changeable during operation of the aircraft 10 by communication with the controller 34 and via communication between the controller 34 and the projector 28. For example, a first image 30 may be displayed for a first time duration, then the projector 28 may be commanded to display a second image 30, different from the first image 30, for a second time duration that may be equal to or different from the first time duration. Further, projectors 28 may be utilized to display communicative images 30 in the event of loss of communication with air traffic controllers, or may display other messages in case of an emergency onboard the aircraft 10.

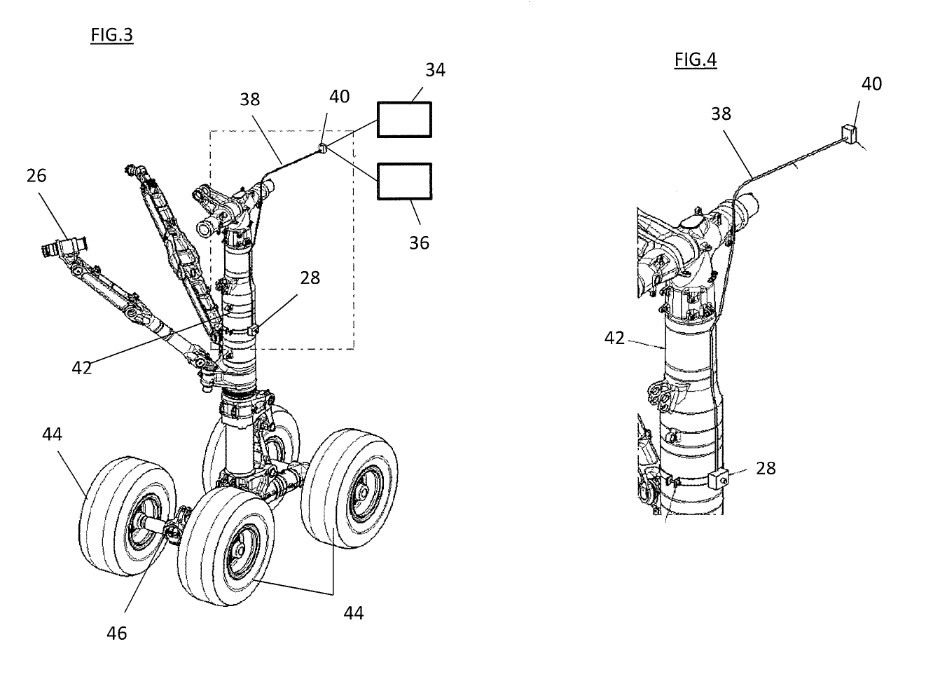

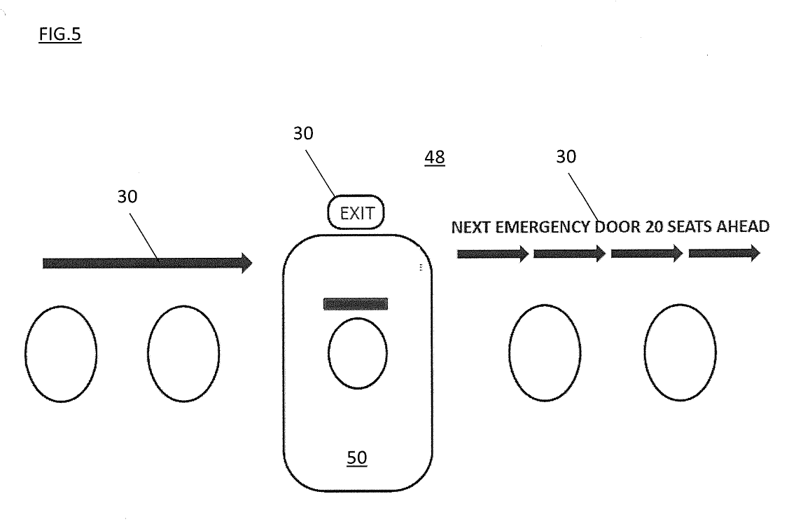

Referring now to FIGS. 3 and 4, illustrated is an embodiment where the projector 28 is mounted to a landing gear assembly, which may be, for example, a nose landing gear assembly 24 or a main landing gear assembly 26. The landing gear assembly includes a landing gear strut 42, with one or more landing gear wheels 44 rotatably connected to the landing gear strut 42 via a landing gear axle 46. The landing gear assembly is configured to be movable between an extended position (shown) and a retracted position (not shown). The extended position is utilized during ground operations of the aircraft 10, such as takeoff and landing, while the retracted position is utilized during other operations of the aircraft, for example, cruise flight. The projector 28 is secured to the landing gear strut 42 and moves with the landing gear assembly from the extended position to the retracted position. In some embodiments, operation of the projector 28 is tied to operation of the landing gear assembly such that when the landing gear assembly is in the extended position, the projector 28 is activated thus projecting an image 30 on the selected aircraft 10 surface. When the landing gear assembly is moved to the retracted position, the projector 28 is deactivated and no image 30 is displayed. Alternatively, operation of the projector 28 may be by flight crew command. Further, the flight crew may be able to override automatic operation of the projector 28 and/or be able to issue commands to the projector 28 to display a particular selected image 30. While illustrated in FIGS. 3 and 4 as being secured to the landing gear strut 42, the projector 28 may alternatively be secured to other components of the landing gear assembly. Further, in other embodiments, the projector 28 may be secured to the fuselage 12 or to other aircraft 10 components, such as an engine cowl or a landing gear door. Additionally, the projector 28 may be located at other aircraft locations, such as at a horizontal tail of the aircraft to project an image, such as an airline logo onto a vertical tail portion of the aircraft.

In other embodiments, such as shown in FIG. 5, projectors 28 may be positioned to project images 30 onto interior surfaces 48 of the aircraft 10. The interior surfaces 48 may include wall, floor or ceiling surfaces. As with images 30 displayed on exterior aircraft surfaces, the images 30 may be static or dynamic and may include commercial messages, informational messages or the like. The informational messages may include images 30 to indicate location of aircraft exits 50, or path to aircraft exits 50, and/or may include other instructional or safety related messages. Further, a traditional flight safety demonstration presently performed by aircraft personnel may be replace with a combination of projected images 30 and audio narration.

The projector 28 and image 30 system disclosed herein has many benefits including utilizing aircraft 10 surfaces not normally utilized for image display, with the capability of dynamically displaying images 30. Further, the projector 28 is programmable allowing for quick changeover of images 30, at a lower cost than existing paint systems.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

1. An aircraft, comprising:
an aircraft body, the aircraft body including one or more exterior surfaces;
a projector secured to a component of the aircraft, the projector configured to selectably project one or more images on the one or more exterior surfaces; and
a controller operably connected to the projector to selectably command projection of the one or more images on the one or more exterior surfaces;
wherein the controller is operably connected to the projector via a wireless connection.

2. (canceled)

3. The aircraft of claim 1, wherein the image is one of a static image or a dynamic image.

4. The aircraft of claim 1, wherein the component is a landing gear strut of the aircraft.

5. The aircraft of claim 4, wherein the projector is activated when the landing gear strut is in an extended position, thereby projecting the one or more images.

6. The aircraft of claim 4, wherein the projector is deactivated when the landing gear strut is in a retracted position, thereby not projecting the one or more images.

7. The aircraft of claim 1, wherein the one or more exterior surfaces are viewable from ground level during normal flight operations of the aircraft.

8. The aircraft of claim 1, wherein the one or more exterior surfaces are one or more of wing surfaces or fuselage surfaces.

9. The aircraft of claim 1, wherein the projector is operably connected to an aircraft electrical system.

10. The aircraft of claim 1, wherein the projector is operably connected to a projector power source independent of an aircraft electrical system.

11. The aircraft of claim 1, wherein the one or more images include one or more commercial advertisements.

12. The aircraft of claim 1, wherein the one or more images are changeable during operation of the aircraft.

13. The aircraft of claim 1, wherein the projector is a laser projector.

14. An image display system for an aircraft, comprising a projector secured to an aircraft component to selectably project an image on a surface of the aircraft; and
a programmable controller operably connected to the projector via a wireless connection to selectably command projection of the image.

15. The image display system of claim 14, wherein the projector is a laser projector.

16. (canceled)

17. The image display system of claim 14, wherein the controller is configured to change the image during operation of the aircraft.

18. The image display system of claim 14, further comprising a projector power source independent of an aircraft electrical system operably connected to the projector.

19. A method of displaying a projected image on an aircraft surface, comprising:
moving a landing gear assembly of the aircraft from a retracted position to an extending position;
activating a projector disposed at the landing gear assembly; and
displaying a projected image at the aircraft surface via activation of the projector; wherein the projector is selectably activated by a programmable controller operably connected to the projector via a wireless connection.

20. The method of claim 19, further comprising changing the projected image during operation of the aircraft.
